(19) United States
(12) Patent Application Publication
(10) Pub. No.: US 2025/0211917 A1
(43) Pub. Date: Jun. 26, 2025

(54) PIEZOELECTRIC ACOUSTIC TRANSDUCER, MANUFACTURING METHOD OF PIEZOELECTRIC ACOUSTIC TRANSDUCER

(71) Applicant: Stanley Electric Co., Ltd., Tokyo (JP)

(72) Inventor: Hideki HIRANO, Tokyo (JP)

(73) Assignee: Stanley Electric Co., Ltd., Tokyo (JP)

(21) Appl. No.: 18/988,949

(22) Filed: Dec. 20, 2024

(30) Foreign Application Priority Data
Dec. 25, 2023 (JP) 2023-217613

(51) Int. Cl. H04R 17/00; H04R 7/06; H04R 7/18; H04R 31/00

(52) U.S. Cl. CPC H04R 17/00; H04R 7/06; H04R 7/18; H04R 31/00

(57) ABSTRACT

A piezoelectric acoustic transducer including: a piezoelectric element section having a piezoelectric film disposed between a pair of electrodes; a diaphragm disposed on a first surface side of the piezoelectric element section; a support section supporting the peripheral portion of the diaphragm; and an elastic film disposed on a second surface side of the piezoelectric element section, where the piezoelectric element section and the diaphragm have a slit dividing the piezoelectric element section and the diaphragm into a plurality of regions, and where elastic film is provided so as to cover an opening of the slit on the piezoelectric element side.

### CROSS-REFERENCE TO RELATED APPLICATION

This application claims the priority benefit under 35 U.S.C. § 119 to Japanese Patent Application No. JP2023-217613 filed on Dec. 25, 2023, which disclosure is hereby incorporated in its entirety by reference

### BACKGROUND

### Technical Field

The present disclosure relates to a piezoelectric speaker.

### Description of the Background Art

Japanese Unexamined Patent Application Publication No. 2010-81573 (Patent Document 1) describes a piezoelectric micro speaker in which a diaphragm is divided into a first region and a second region, the first region being made of a material that maximizes the excitation force, and the second region being made of a material that has a relatively smaller initial stress and a lower Young's modulus than that of the first region.

In a specific aspect, it is an object of the present disclosure to provide a technique that can further increase sound pressure of a piezoelectric acoustic transducer.

### SUMMARY

A piezoelectric acoustic transducer according to one aspect of the present disclosure is a piezoelectric acoustic transducer including: a piezoelectric element section having a piezoelectric film disposed between a pair of electrodes; a diaphragm disposed on a first surface side of the piezoelectric element section; a support section supporting the peripheral portion of the diaphragm; and an elastic film disposed on a second surface side of the piezoelectric element section, where the piezoelectric element section and the diaphragm have a slit dividing the piezoelectric element section and the diaphragm into a plurality of regions, and where elastic film is provided so as to cover an opening of the slit on the piezoelectric element side.

A manufacturing method of a piezoelectric acoustic transducer according to one aspect of the present disclosure is a manufacturing method of a piezoelectric acoustic transducer including: (a) forming a laminated film of a first conductive film, a piezoelectric film, and a second conductive film on one surface side of a substrate including a laminated support layer, a buried insulating layer, an active layer, and an oxide film; (b) forming a slit from the one surface side of the substrate through the oxide film, the active layer, the first conductive film, the piezoelectric film, and the second conductive film to reach the buried insulating layer; (c) forming an elastic film on the one surface side of the substrate and within the slit; (d) removing the support layer and the buried insulating layer from an other surface side of the substrate in a predetermined range including the slit; and (e) removing the elastic film embedded in the slit from the other surface side of the substrate.

According to the above configurations, it is possible to further increase sound pressure of a piezoelectric acoustic transducer.

### BRIEF DESCRIPTION OF THE DRAWINGS

FIG. 1A is a schematic cross-sectional view showing the configuration of a piezoelectric acoustic transducer according to one embodiment.

FIG. 1B is a schematic plane view showing the configuration of a piezoelectric acoustic transducer according to one embodiment.

FIG. 2A to FIG. 2D are schematic cross-sectional views for explaining one example of a manufacturing method of a piezoelectric acoustic transducer.

FIG. 3A to FIG. 3D are schematic cross-sectional views for explaining one example of a manufacturing method of a piezoelectric acoustic transducer.

FIG. 4A, FIG. 4B, FIG. 4C, and FIG. 4D are partial enlarged views for explaining a detailed shape of a resin film in the vicinity of a slit in a piezoelectric acoustic transducer.

FIG. 5A, FIG. 5B, FIG. 5C, and FIG. 5D are partial enlarged views for explaining a detailed shape of a resin film in the vicinity of a slit in a piezoelectric acoustic transducer.

FIG. 6A and FIG. 6B are partial enlarged views for explaining a detailed shape of a resin film in the vicinity of a slit in a piezoelectric acoustic transducer.

FIG. 7 is a diagram for explaining the characteristics of a piezoelectric acoustic transducer of working examples and comparative examples.

### DESCRIPTION OF THE PREFERRED EMBODIMENTS

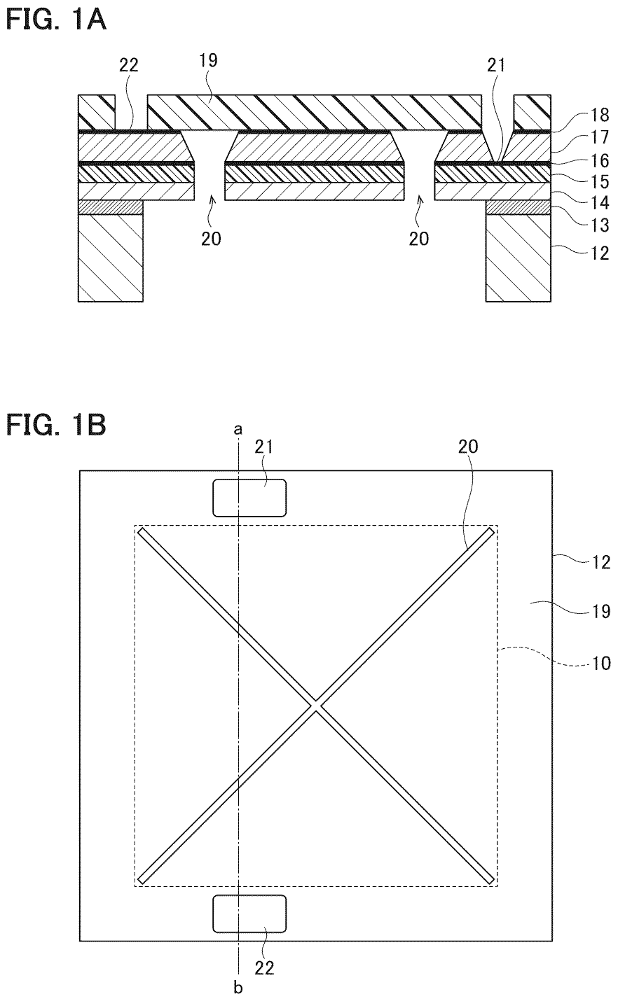

FIG. 1A is a schematic cross-sectional view showing the configuration of a piezoelectric acoustic transducer according to one embodiment. Further, FIG. 1B is a schematic plane view showing the configuration of a piezoelectric acoustic transducer according to one embodiment. Here, the cross-sectional view of FIG. 1A corresponds to the cross section along line a-b shown in FIG. 1B. The piezoelectric acoustic transducer of the present embodiment has a piezoelectric body, and generates sound by using the movement of this piezoelectric body to generate a diaphragm, and is also known as a piezoelectric speaker.

The piezoelectric acoustic transducer is configured to include a support layer 12, a BOX layer 13, an active layer 14, an upper oxide film 15, a lower electrode film 16, a piezoelectric film 17, an upper electrode film 18, and a resin film 19. Here, note that in this specification, the terms “upper, lower” are used merely to indicate the upper and lower positions in the figures for the sake of convenience, and have no other special meaning.

The support layer 12 is a layer made of Si (silicon), for example, and in the present embodiment, is configured in a frame shape in a plane view. This support layer 12 has a function of supporting the peripheral portion of a diaphragm, which will be described later.

The BOX layer 13 is a buried insulating layer provided between the support layer 12 and the active layer 14, and is a layer made of a thermally oxidized silicon film, for example. The BOX layer 13 is configured in a frame shape with the same shape as the support layer 12, for example, and supports the diaphragm together with the support layer 12.

The active layer 14 is a semiconductor layer provided on the upper side of the BOX layer 13, and is a layer made of a Si film, for example.

The upper oxide film 15 is an insulating film provided on the upper side of the active layer 14, and is a silicon oxide film, for example.

The lower electrode film 16 is an electrode film provided on the upper side of the upper oxide film 15 and is made of a thin film of Pt (platinum), for example. Similarly, the upper electrode film 18 is an electrode film provided on the upper side of the piezoelectric film 17 and is made of a thin film of Pt (platinum), for example. A piezoelectric element section is configured to include the lower electrode film 16 and the upper electrode film 18 (i.e., a pair of electrodes) and the piezoelectric film 17 disposed therebetween.

The piezoelectric film 17 is a film formed using a material that has piezoelectric effect, that is, a deforming property when a voltage is applied, or conversely, a property of generating a voltage when deformed by the application of pressure. As the piezoelectric film 17, for example, a film made of a metal oxide film material such as lead zirconate titanate (PZT) or potassium sodium niobate (KNN) is used. The piezoelectric film 17 is provided between the lower electrode film 16 and the upper electrode film 18.

The resin film 19 is an elastic film formed to cover the upper side of the upper electrode film 18, and is made of a polyimide film, for example. The resin film 19 serves to close one opening (the opening on the side of the piezoelectric element section) of the slit 20 which will be described later. In the present embodiment, the resin film 19 is provided on the upper side of the upper electrode film 18 so that no portion is embedded in the slit 20. Here, the resin film 19 may be provided so that there is a portion embedded in the slit 20 with a thickness that does not reach the upper oxide film 15 in the slit 20 (i.e., a thickness that does not reach the diaphragm). The surface of the resin film 19 exposed toward the inside of the slit 20 is roughly flat. A part of the resin film 19 may penetrate the upper space. In that case, it is preferable that the total area of the penetrated portion is 10% or less of the total area of the slit.

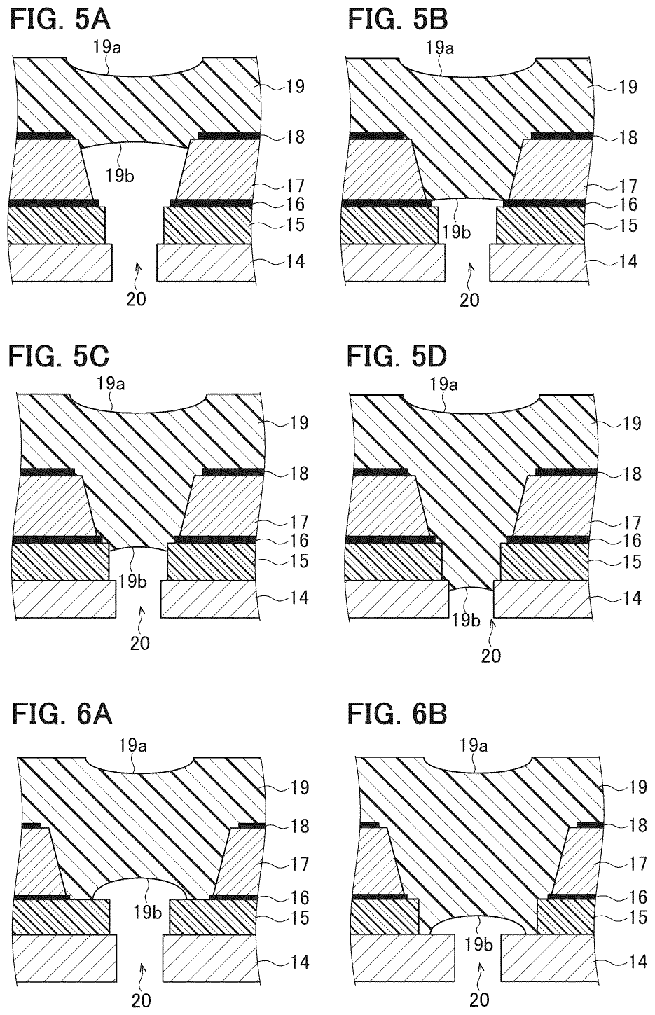

The slit 20 is a hole or a groove configured to penetrate the active layer 14, the upper oxide film 15, the lower electrode film 16, the piezoelectric film 17, and the upper electrode film 18. As shown in FIG. 1A, the slit 20 in the present embodiment has a substantially constant diameter or width in the portion penetrating the active layer 14, the upper oxide film 15, and the lower electrode film 16, and a tapered shape in which the diameter or width gradually increases along the direction toward the resin film 19 (upward in the figure) in the portion penetrating the piezoelectric film 17. The slit shape may be constant in diameter or width in each layer, or may have a different tapered shape in each layer. Furthermore, as exemplified in FIG. 5A to FIG. 5D and FIG. 6A to FIG. 6B to be described later, the slit 20 may have a larger inner diameter (inner width) at the portion defined by the ends (sidewalls) of the upper oxide film 15, the lower electrode 16, the piezoelectric film 17, and the upper electrode 18 than the inner diameter (inner width) at the portion defined by the ends (sidewalls) of the active layer 14, the upper oxide film 15, and the lower electrode film 16. This is a structure for absorbing alignment errors in the photolithography method. The above description where the active layer 14, the upper oxide film 15, and the lower electrode film 16 is expressed as having “a substantially constant diameter or width” or “constant in diameter or width” also includes differences in these diameters or widths.

The slit 20 is configured in the shape of two long intersecting rectangles (X-shape) in a plane view, as shown in FIG. 1B. Due to the presence of this slit 20, the piezoelectric element section and the portions of the active layer 14 and the upper oxide film 15 that are not supported by the support layer 12 and BOX layer 13 are divided into four regions.

The rectangular portion indicated by a dotted line in FIG. 1B is the portion that functions as a diaphragm 10 that vibrates caused by the piezoelectric element section. This diaphragm 10 is part of the active layer 14 and the upper oxide film 15 described above, and its peripheral portion is supported by the support section 12 and the BOX layer 13.

An electrode pad 21 is an exposed portion of a part of the lower electrode film 16. This electrode pad 21 is exposed through an opening portion that penetrates the resin film 19, the piezoelectric film 17, and the upper electrode film 18 at a predetermined position where it overlaps with the support layer 12 in a plane view.

An electrode pad 22 is an exposed portion of a part of the upper electrode film 18. This electrode pad 22 is exposed through an opening portion that penetrates the resin film 19 at a predetermined position where it overlaps with the support layer 12 in a plane view.

By providing wirings (not shown) or the like to the electrode pads 21 and 22, an electrical signal (voltage signal, current signal, etc.) can be applied to the lower electrode film 16 and the upper electrode film 18, and the piezoelectric element section consisting of the piezoelectric film 17, etc. can be operated.

Here, a preferred Young's modulus for the diaphragm 10, the piezoelectric film 17, and the resin film 19 will be described. An elastic film that makes up the resin film 19 preferably has a lower Young's modulus than that of the diaphragm 10 and the piezoelectric film 17. Specifically, single crystal silicon and silicon oxide film that make up the diaphragm 10 have Young's moduli of 160 GPa and 70 GPa or more respectively, and the piezoelectric film 17 has a Young's modulus of 75 GPa or more, for example, while the resin film 19 preferably has a Young's modulus of 10 GPa or less.

The resin film 19 preferably has a Young's modulus of GPa or less so as not to impede the vibration of the diaphragm 10, but a Young's modulus of 0.2 MPa or more is preferable because a Young's modulus that is too low will cause the resonance sharpness (Q value) of the speaker to become too high and the frequency characteristics to deteriorate. The resin film 19 preferably has a Young's modulus of 0.5 MPa or more to 5.0 GPa or less, and more preferably has a Young's modulus of 1 MPa or more to 2 GPa or less. The polyimide film, as an example described above, has a Young's modulus of about 3.5 GPa, which satisfies one example of the preferred conditions described above. Further, when the resin film 19 is formed using a photosensitive epoxy resin, the Young's modulus is about 1.8 GPa, and the Young's modulus of silicone resin (PDMS) is 2 MPa, which satisfies one example of the preferred conditions described above.

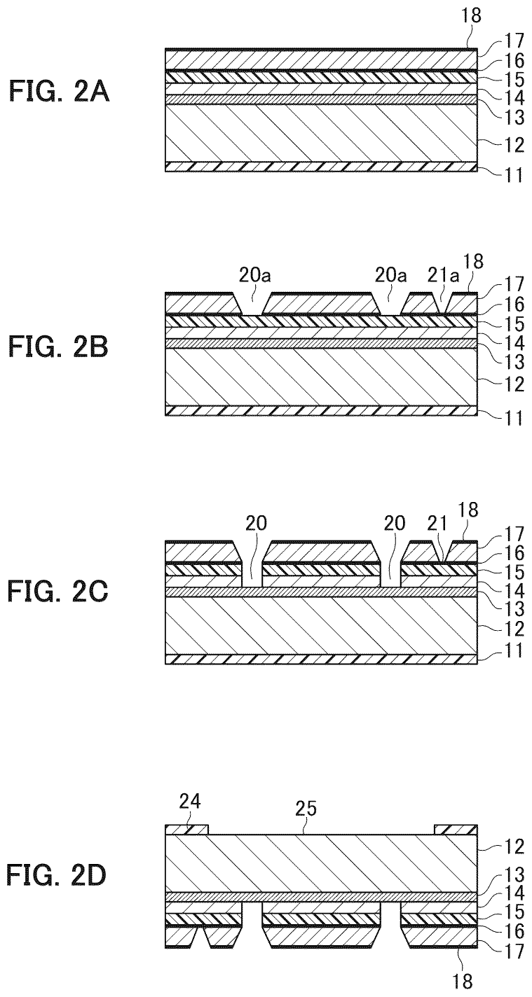

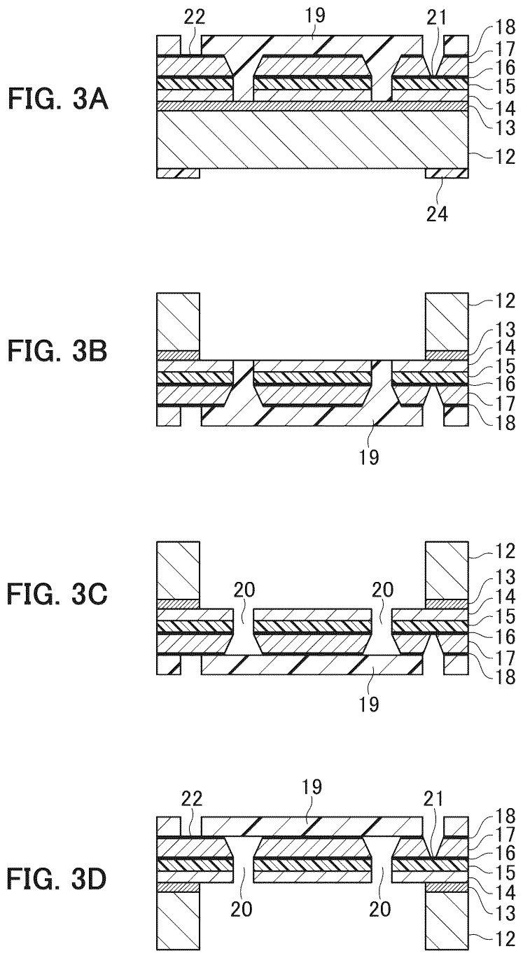

FIG. 2A to FIG. 2D and FIG. 3A to FIG. 3D are schematic cross-sectional views for explaining one example of a manufacturing method of a piezoelectric acoustic transducer. In the manufacturing method exemplified here, a piezoelectric acoustic transducer is formed using an SOI substrate. This will be described in detail below.

First, an SOI substrate is prepared, which is configured having the lower oxide film 11, the support layer 12, the BOX layer 13, the active layer 14, and the upper oxide film 15. A laminated film consisting of the lower electrode film 16, the piezoelectric film 17, and the upper electrode film 18 is formed on the upper side of the upper oxide film 15 (FIG. 2A).

The lower electrode film 16 and the upper electrode film 18 are each obtained by depositing a metal such as Pt, Ir, Au, Mo, Cu, or Al to a thickness of several hundred microns using a deposition method such as sputtering method or vacuum deposition method. Further, the piezoelectric film 17 is obtained by depositing a piezoelectric material such as PZT, KNN, AlN, or Zno to a thickness of several microns using sputtering method.

An opening 20a is formed that penetrates the lower electrode film 16, the piezoelectric film 17, and the upper electrode film 18 (FIG. 2B). Further, an opening 21a is formed that penetrates the lower electrode film 16 and the piezoelectric film 17 and exposes the electrode pad 21, which is a part of the lower electrode film 16. Each of the openings 20a and 21a can be formed using a dry etching method, for example.

Here, if a protective film such as a silicon oxide film or a silicon nitride film is to be formed after the openings 20a, 21a are formed, the protective film on the openings 20a, 21a and the electrode pad 21 is removed by a dry etching method or the like after the film formation.

The upper oxide film 15 is removed through the opening 20a by dry etching method or the like, and then the active layer 14 is removed using the BOX layer 13 as a stop layer by Bosch method, which is a silicon vertical etching method. As a result, the slit 20 reaching the BOX layer 13 is formed (FIG. 2C).

The entire substrate is inverted and a portion of the lower oxide film 11 on the back side is partially removed by dry etching method or the like, exposing a portion 25 of the support layer 12. As a result, a back surface processing mask 24 made from the remaining lower oxide film 11 is obtained (FIG. 2D).

Again, the entire substrate is inverted, and the resin film 19 such as a negative photosensitive polyimide film is applied by spin coating method or the like to the upper side of the upper electrode film 18. Next, using photolithography method, the portions of the resin film 19 that overlap the electrode pads 21, 22 in a plane view are selectively removed, after which it is baked in a nitrogen atmosphere at 300° C. for 30 minutes, for example (FIG. 3A).

Again, the entire substrate is inverted, and using the back surface processing mask 24 as a mask, the support layer 12 is removed by Bosch method or the like until it reaches the BOX layer 13, and then the BOX layer 13 and the back surface processing mask 24 are removed by dry etching method or the like (FIG. 3B). As a result, the portions of the resin film 19 embedded in the slits 20 are exposed.

The portions of the resin film 19 embedded in the slits are removed from the back side of the substrate by reactive ion etching process using oxygen plasma, for example (FIG. 3C). At this time, by controlling the processing time and other conditions, it is possible to select whether to remove all of the resin film 19 in the slits 20, or to remove it to a thickness that does not reach the height of the upper oxide film 15, or to remove it to a thickness that does not reach the height of the active layer 14.

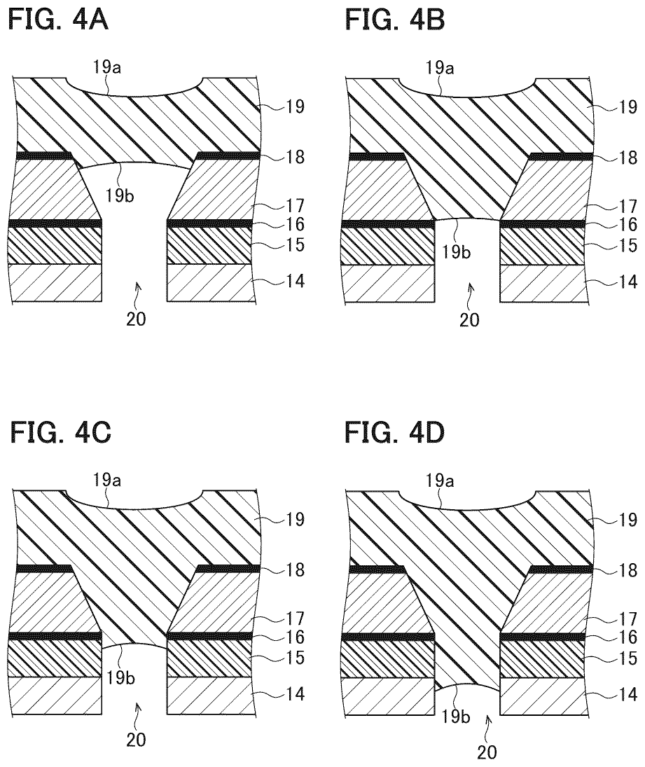

Through the above steps, the piezoelectric acoustic transducer of the present embodiment is obtained (FIG. 3D). In the piezoelectric acoustic transducer of the present embodiment, one opening of the slit 20 is covered and blocked by the resin film 19. Basically, the resin film 19 is hardly embedded inside the slit 20, and the surface of the resin film 19 facing the slit 20 is roughly flat. A detailed shape of the resin film 19 facing the slit 20 in this case is shown in an enlarged view of FIG. 4A. As shown in the figure, the resin film 19 has a recess (a concave cross section) 19a on the surface farther from the slit 20, and also has a recess (a concave cross section) 19b on the surface facing the inside of the slit 20. And, a small portion of the resin film 19 penetrates into the inside of the slit 20. Here, note that the gap formed by the etching process may reach the upper side of the slit 20.

In the piezoelectric acoustic transducer of the present embodiment, the resin film 19 may be in a state where it is not embedded in the entire interior of the slit 20, and as shown in the enlarged view of FIG. 4B, the resin film 19 may be embedded in the slit 20 to a thickness that does not reach the height of the active layer 14, etc. Further, as shown in the enlarged view of FIG. 4C, the resin film 19 may be provided so that there is a portion embedded in the slit 20 to a thickness that does not reach the active layer 14. Further, as shown in the enlarged view of FIG. 4D, the resin film 19 may be provided so that there is a portion embedded in the slit 20 to a thickness that reaches the active layer 14. Even in these cases, the resin film 19 has the same recesses 19a and 19b as described above. Further, a hole (a through portion) may be formed in which part of the resin film 19 penetrates the upper space. However, if the dimension of the through portion is great, the sound pressure of the piezoelectric acoustic transducer will decrease due to air leakage, therefore in order to obtain the effect of the present embodiment, it is preferable that the total area of the through portion is 10% or less of the total area of the slits. Here, as described above, as shown in the enlarged views of FIG. 5A to FIG. 5D and FIG. 6A to FIG. 6B, the slit 20 may have an inner diameter (inner width) larger at the portion defined by the ends (side walls) of the upper oxide film 15, the lower electrode 16, the piezoelectric film 17, and the upper electrode 18 than the inner diameter (inner width) at the portion defined by the ends (side walls) of the active layer 14, the upper oxide film 15, and the lower electrode film 16. In these cases, the shape of the recess 19b may be a shape that extends over the side walls of the active layer 14, the upper oxide film 15, the lower electrode film 16, etc., as exemplified in FIG. 5A to FIG. 5D, or a shape that extends over one surface (the surface closer to the resin film 19) of the active layer 14 or the upper oxide film 15, as exemplified in FIG. 6A to FIG. 6B. If a protective layer is formed, the protective layer may be larger than the inner diameter (inner width) of the portion defined by the slit 20.

The unique effects of having these recesses 19a, 19b will now be described. First, the film thickness of the resin film 19 covering the slit 20 becomes continuously thinner from the outer edge of the slit 20 toward the center in a plane view, which increases the damping effect compared to when the thickness of the elastic film 19 is constant, and the total harmonic distortion (THD), which is one of speaker's characteristic values, can be reduced. Further, the thinner the elastic film 19 which covers the slit 20, the easier it is for the diaphragm 10 to displace, thereby the sound pressure level can be improved. At this time, there is a possibility that the diaphragm 10 may be easily damaged by large vibrations or external impacts. However, by making the thickness of the elastic film 19 at the contact point at the outer edge of the slit 20 thicker, the strength can be increased while maintaining the displacement amount of the diaphragm 10.

The recesses 19a, 19b of the resin film 19 are obtained through the manufacturing method described above. Specifically, a paint with the resin film 19 dissolved in a solvent is applied, and in the process of drying the solvent, the amount of hardening shrinkage is relatively large in the portion that overlaps with the slit 20 (i.e. directly above it), thus recess 19a is obtained in the portion that overlaps with the slit 20. Further, when etching the resin film 19 inside the slit 20 from the slit 20 side, the etching rate is relatively slow in the area close to the inner wall of the slit 20, therefore etching progresses relatively easily in the area far from the inner wall of the slit 20, resulting in the recess 19b.

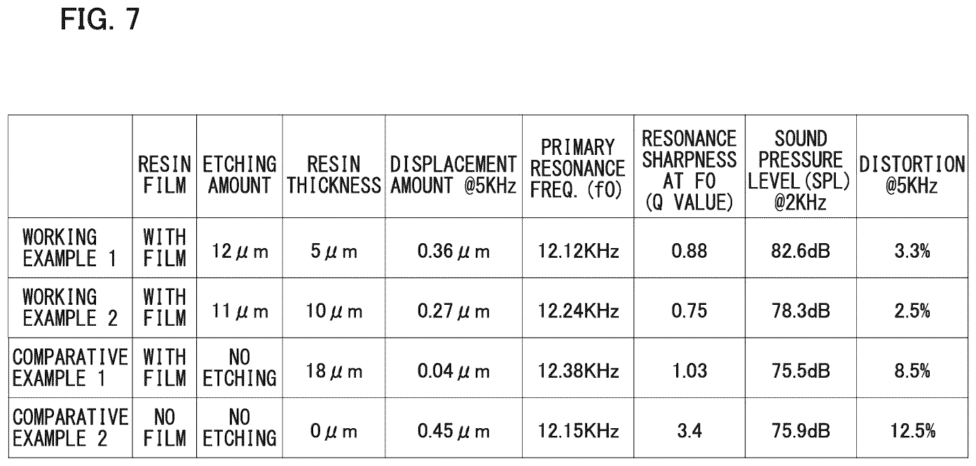

FIG. 7 is a diagram for explaining the characteristics of the piezoelectric acoustic transducers of working examples and comparative examples. Working examples 1 and 2 and comparative examples 1 and 2 were prepared, which have a common configuration except for the configuration of the resin film 19 that covers and seals the slit 20, and the characteristics of each example was investigated. Here, the film thickness dimensions of each layer in each working example and comparative example are the same, and the film thicknesses of the active layer 14, the upper oxide film 15, the lower electrode film 16, the piezoelectric film 17, and the upper electrode film 18 are 9 μm, 1 μm, 0.2 μm, 2 μm, and 0.2 μm, respectively. In other words, the depth of the slit becomes 12.4 μm.

In working example 1, the amount of etching of the resin film 19 in the slit 20 is set to 12 μm, and the resin thickness (film thickness) of the resin film 19 at the center of the portion that closes the opening of the slit 20 is set to 5 μm. In other words, this is a working example in which the resin film 19 is not embedded in the slit 20 at all (refer to FIG. 4A). In this case, the upper periphery of the slit may be partially etched. In the piezoelectric acoustic transducer of working example 1, the displacement amount of the piezoelectric element section when a 5 kHz sine wave signal was input was 0.36 μm, the sound pressure level (SPL) at 2 kHz when the sine wave signal was swept from 1 kHz to 20 kHz was 82.6 dB, and the total harmonic distortion was 3.3%. Here, the sound pressure level was evaluated by attaching an IEC60318-5 standards coupler (hereinafter the same). The primary resonance frequency (f0) was 12.12 kHz, and the resonance sharpness (Q value) at f0 was 0.88.

In working example 2, the inner width of the lower electrode film 16 is 5 μm larger on one side than the inner width of the upper oxide film 15, i.e., in a structure having a terrace of the upper oxide film 15 with a width of 5 μm, the etching amount of the resin film 19 in the slit 20 is 11 μm. In this case, the side etching amount of the resin film 19 from the opening of the slit 20 with the upper oxide film 15 becomes 2 μm. That is, this is a working example of an embodiment in which the resin film 19 is embedded in the slit to a thickness that does not reach the height of the active layer 14, etc. (refer to FIG. 6A). In the piezoelectric acoustic transducer of working example 2, the displacement amount of the piezoelectric element section when a 5 kHz sine wave signal was input was 0.27 μm, the sound pressure level (SPL) at 2 kHz when the sine wave signal was swept from 1 kHz to 20 kHz was 78.3 dB, and the total harmonic distortion was 2.5%. The primary resonance frequency (f0) was 12.24 kHz, and the resonance sharpness (Q value) at f0 was 0.75.

In comparative example 1, the amount of etching of the resin film 19 in the slit 20 is set to 0 μm, and the resin thickness (film thickness) of the resin film 19 is set to 18 μm. That is, this is a comparative example in which the resin film 19 is embedded entirely inside the slit 20. In the piezoelectric acoustic transducer of comparative example 1, the displacement amount of the piezoelectric element section when a sine wave signal of 5 kHz was input was 0.04 μm, the sound pressure level (SPL) at 2 kHz when the sine wave signal was swept from 1 kHz to 20 kHz was 75.5 dB, and the total harmonic distortion was 8.5%. The primary resonance frequency (f0) was 12.38 kHz, and the resonance sharpness (Q value) at f0 was 1.03.

Comparative example 2 is a comparative example in which a resin film 19 that covers the slit 20 is not provided. In the piezoelectric acoustic transducer of comparative example 2, the displacement amount of the piezoelectric element section when a 5 kHz signal was input was 0.45 μm, the sound pressure level (SPL) at 2 kHz when a sine wave signal was swept from 1 kHz to 20 kHz was 75.9 dB, and the total harmonic distortion was 12.5%. The primary resonance frequency (f0) was 10.15 kHz, and the resonance sharpness (Q value) at f0 was 3.4.

In both working examples 1 and 2, sufficient displacement amount and sound pressure level were obtained, and total harmonic distortions were also small. Comparing working example 1 and working example 2, working example 2, in which the resin film inside the slit 20 was thicker, had a slightly lower sound pressure level, but less total harmonic distortion and a lower Q value. In any case, each characteristic was superior to comparative examples 1 and 2.

In comparative example 1, the resin film 19 inside the slit 20 is thick, which increases rigidity, resulting in a lower displacement amount and sound pressure level, and a greater total harmonic distortion. In comparative example 2, there is no resin film 19 and the inside of the slit 20 is hollow, so the displacement amount at the resonant frequency was great, but the displacement amount at 5 kHz was minimal. Further, air leakage occurred because the inside of the slit was hollow, which minimized the sound pressure level. Furthermore, the total harmonic distortion also became extremely great.

According to the above described embodiment and working examples, it is possible to further increase the sound pressure of the piezoelectric acoustic transducer. Furthermore, the total harmonic distortion can also be reduced.

Here, note that the present disclosure is not limited to the content of the above described embodiment, and various modifications can be made within the scope of the gist of the present disclosure. For example, between the support layer 12, the BOX layer 13, the active layer 14, the upper oxide film 15, the lower electrode film 16, the piezoelectric film 17, the upper electrode film 18, and the resin film 19 in the above described embodiment, other films or layers may be added as long as they do not interfere with the intended function of the piezoelectric acoustic transducer. Further, the materials, film thicknesses, manufacturing methods, and other conditions shown in the above described embodiment are merely examples and are not limited thereto. For example, any resin can be used as the elastic film as long as it can be easily applied by spin coating method, has heat resistance to a process temperature (120° C.) or higher, and has environmental resistance to humidity, water, visible light, ultraviolet light, and the like. For example, the elastic film can be formed using polyvinyl chloride, amorphous fluororesin, non-photosensitive polyimide, modified silicone resin, polycarbonate, modified nylon, or the like.

The present application is based on, and claims priority from, JP Application Serial Number, 2023-217613 filed on Dec. 25, 2023, the disclosure of which is hereby incorporated by reference herein in its entirety.

### DESCRIPTION OF SYMBOLS

10: Diaphragm
11: Lower oxide film
12: Support layer
13: BOX layer
14: Active layer
15: Upper oxide film
16: Lower electrode film
17: Piezoelectric film
18: Upper electrode film
19: Resin film, Elastic film
20: Slit
21, 22: Electrode pad

What is claimed is:

1. A piezoelectric acoustic transducer comprising:
a piezoelectric element section having a piezoelectric film disposed between a pair of electrodes;
a diaphragm disposed on a first surface side of the piezoelectric element section;
a support section supporting the peripheral portion of the diaphragm; and
an elastic film disposed on a second surface side of the piezoelectric element section,
wherein the piezoelectric element section and the diaphragm have a slit dividing the piezoelectric element section and the diaphragm into a plurality of regions, and
wherein elastic film is provided so as to cover an opening of the slit on the piezoelectric element side.

2. The piezoelectric acoustic transducer according to claim 1,
wherein the elastic film is provided so that no part of the elastic film is embedded in the slit.

3. The piezoelectric acoustic transducer according to claim 1,
wherein the elastic film is provided so that there is a portion embedded in the slit with a thickness that does not reach the diaphragm.

4. The piezoelectric acoustic transducer according to claim 1,
wherein the surface of the elastic film facing into the slit has a concave cross section.

5. The piezoelectric acoustic transducer according to claim 1,
wherein the surface of the elastic film opposite to a surface facing into the slit has a concave cross section.

6. The piezoelectric acoustic transducer according to claim 1,
wherein the elastic film is made of a resin film.

7. The piezoelectric acoustic transducer according to claim 1,
wherein a Young's modulus of the elastic film is lower than a Young's modulus of each of the diaphragm and the piezoelectric film.

8. The piezoelectric acoustic transducer according to claim 6,
wherein a Young's modulus of the elastic film is 0.2 MPa or more and 10 GPa or less.

9. A manufacturing method of a piezoelectric acoustic transducer comprising:
(a) forming a laminated film of a first conductive film, a piezoelectric film, and a second conductive film on one surface side of a substrate including a laminated support layer, a buried insulating layer, an active layer, and an oxide film;
(b) forming a slit from the one surface side of the substrate through the oxide film, the active layer, the first conductive film, the piezoelectric and the second conductive film to reach the buried insulating layer;
(c) forming an elastic film on the one surface side of the substrate and within the slit;
(d) removing the support layer and the buried insulating layer from an other surface side of the substrate in a predetermined range including the slit; and
(e) removing the elastic film embedded in the slit from the other surface side of the substrate.

10. The manufacturing method of a piezoelectric acoustic transducer according to claim 9,
wherein in the above described (e), the elastic film within the slit is completely removed.

11. The manufacturing method of a piezoelectric acoustic transducer according to claim 9,
wherein in the above described (e), the elastic film in the slit is removed to a thickness that does not reach the height of the active layer and the oxide film.
